(19) United States
(12) Patent Application Publication
(10) Pub. No.: US 2026/0213425 A1
(43) Pub. Date: Jul. 23, 2026

(54) MULTIBEAM SECTOR-SPLITTING BASE STATION ANTENNAS HAVING MODIFIED NOLEN MATRIX-BASED BEAMFORMING NETWORKS

(71) Applicant: Outdoor Wireless Networks LLC, Richardson, TX (US)

(72) Inventors: Sharal DHANAPAL, Visakhapatnam (IN); Xiangyang AI, Planso, TX (US); Kumara Swamy KASANI, GodavariKahani (IN); Chengcheng TANG, Murphy, TX (US)

(21) Appl. No.: 19/134,285

(22) PCT Filed: Nov. 15, 2023
(86) PCT No.: PCT/US2023/079784

§ 371 Date: May 30, 2025

(30) Foreign Application Priority Data
Dec. 1, 2022 (IN) 202241069502

(51) Int. Cl. H01Q 15/24; H01Q 3/36; H01Q 21/06

(52) U.S. Cl. CPC H01Q 15/24; H01Q 3/36; H01Q 21/062

(57) ABSTRACT

Multibeam base station antennas include first through M first polarization RF ports, an antenna array that includes N columns of radiating elements, and a first polarization beamforming network having M rows and N columns of directional couplers, where each row has a different number of directional couplers, where M and N are natural numbers, wherein the last directional coupler in a top row has a port that is coupled to ground via a matched termination.

### FIELD OF THE INVENTION

The present invention generally relates to radio communications and, more particularly, to multibeam sector-splitting base station antennas utilized in cellular and other communications systems.

### BACKGROUND

Cellular communications systems are well known in the art. In a typical cellular communications system, a geographic area is divided into a series of regions that are referred to as “cells,” and each cell is served by a base station. The base station may include baseband equipment, radios and base station antennas that are configured to provide two-way radio frequency (“RF”) communications with subscribers that are positioned throughout the cell. In many cases, the cell may be divided into a plurality of “sectors” in the azimuth plane (a horizontal plane that bisects the antenna that is parallel to the plane defined by the horizon), and separate base station antennas provide coverage to each of the sectors. The base station antennas are often mounted on a tower or other raised structure, with the radiation patterns (“antenna beams”) that are generated by the antennas directed outwardly to provide service to the respective sectors.

A common base station configuration is a “three sector” configuration in which a cell is divided into three 120° sectors in the azimuth plane, and the base station includes three base station antennas that provide coverage to the three respective sectors. Typically, each base station antenna will include one or more vertically-extending columns of radiating elements, each of which is configured to generate a separate antenna beam (or two antenna beams, if dual-polarized radiating elements are used, as is well understood in the art). Each column of radiating elements is connected to a feed network that subdivides an RF signal and feeds each sub-component of the RF signal to a respective subset of one or more of the radiating elements in the column. Typically, each radiating element is configured to generate a radiation pattern that has a Half Power Beam Width (“HPBW”) in the azimuth plane of about 65°, which ensures that the antenna beam provides good coverage throughout a 120° sector. The sub-components of the RF signal are phased so that the radiation patterns generated by each subset of one or more radiating elements constructively combine to produce a composite antenna beam having a narrowed HPBW (e.g., 15°-30°) in the elevation (vertical) plane.

As capacity requirements have grown, cellular network operators are now dividing some cells into more than three sectors. For example, cells may now be divided into six, nine, twelve, fifteen or eighteen sectors in the azimuth plane. Typically, multibeam “sector-splitting” antennas are used when cells are divided into more than three sectors. A multibeam sector-splitting antenna refers to a base station antenna that generates multiple antenna beams (per polarization) that have narrowed beamwidths in the azimuth plane (i.e., azimuth HPBWs of less than about 65°, and typically less than about 35°), where the pointing directions of the multiple antenna beams are designed to split a sector into a plurality of sub-sectors. This allows a single base station antenna to generate the multiple antenna beams (per polarization) that provide coverage to the respective sub-sectors of a 120° sector.

For example, a six-sector base station will divide each 120° sector in the azimuth plane into two 60° sub-sectors. Such a six-sector base station will typically be served by three base station antennas that are each implemented as a “twin-beam” antenna that is designed to generate first and second antenna beams (per polarization) that provide coverage to the respective first and second 60° sub-sectors of each 120° sector. Each antenna beam may have a HPBW in the azimuth plane of about 30-35°. The first antenna beam may point at an angle of about −27° to −30° in the azimuth plane from the “boresight” pointing direction of the antenna and the second antenna beam may point at an angle of about 27° to 30° in the azimuth plane from the “boresight” pointing direction of the antenna. The boresight pointing direction of the antenna is the center, in the azimuth plane, of the 120° sector served by the antenna. In this fashion, the 120° sector is split into two 60° sub-sectors that are covered by the respective first and second antenna beams.

Providing cellular service in large venues such as stadiums, arenas, convention centers, concert halls and the like may be particularly challenging, as very larger numbers of users may be located in a very small area. In such venues, multibeam sector-splitting base station antennas that generate four, five, six or more antenna beams per polarization may be used, where each antenna beam provides coverage to a respective 20°-30° (or smaller) sub-sector in the azimuth plane. When a 120° sector is sub-divided into a large number of sub-sectors (e.g., 4-6 sub-sectors), the system capacity can be increased significantly because the RF energy of each antenna beam is focused into a smaller area and therefore provides a higher antenna gain.

In order to generate antenna beams that have narrowed beamwidths in the azimuth plane, multibeam sector-splitting base station antennas typically include at least one multi-column antenna array, since transmitting an RF signal through multiple columns of radiating elements acts to expand the aperture of the antenna in the azimuth plane, which shrinks the azimuth beamwidths of the generated antenna beams. For example, a twin-beam antenna will typically use a three or four column array of radiating elements, while more columns are provided for multibeam antennas that generate three or more antenna beams per polarization. While separate multi-column arrays of radiating elements may be used to generate each antenna beam, such an approach is typically commercially unacceptable because such an approach results in a very large and costly antenna. Thus, multibeam antennas typically include beamforming networks, which allow multiple RF signals to be transmitted through a single multi-column array of radiating elements to generate multiple corresponding antenna beams that point in different directions.

For example, multibeam sector-splitting antennas are well known in the art that include multiple RF ports (per polarization) that are coupled to a multi-column array of radiating elements through a Butler Matrix based beamforming network. The beamforming network generates multiple antenna beams (per polarization) based on the RF signals input at the multiple RF ports, and the antenna beams are electrically steered so that each antenna beam provides coverage to a different sub-sector of, for example, a 120° sector. Unfortunately, Butler Matrix based multibeam antennas may have a number of drawbacks. In particular, Butler Matrix based beamforming networks are expensive, and the azimuth beamwidths of the generated antenna beams may be larger than desired, which both reduces the antenna gain and increases interference between sub-sectors. Butler Matrix based beamforming network multibeam antennas also experience so-called “beam peak walking,” which refers to a phenomena where the azimuth pointing angle of each antenna beam shifts depending upon the frequency of the input RF signals. Beam peak walking occurs in Butler Matrix-based beamforming networks because the phase differences between the outputs of the Butler Matrix are independent of the frequencies of the RF signals input to the Butler Matrix, while the spacing between the columns of radiating elements is frequency dependent.

### SUMMARY

Pursuant to embodiments of the present invention, multibeam antennas are provided that include first through M first polarization RF ports, an antenna array that includes N columns of radiating elements, and a first polarization beamforming network having M rows and N columns of directional couplers, where each row has a different number of directional couplers, where M and N are natural numbers.

In some embodiments, a top row of the M rows of directional couplers has the most directional couplers and each row below the top row has one less directional coupler than the row above it.

In some embodiments, a coupling port of each directional coupler in the top row of the M rows of directional couplers is coupled to a respective one of the N columns of radiating elements.

In some embodiments, wherein a first directional coupler in each of the rows of directional couplers is coupled to a respective one of the first polarization RF ports.

In some embodiments, a through port of the last directional coupler in the top row of the M rows of directional couplers is coupled to electrical ground via a matched termination.

In some embodiments, a through port of each directional coupler in each of the M rows of directional couplers except for a last directional coupler in each of the M rows of directional couplers is coupled to the input port of a respective adjacent directional coupler in the row through a respective first delay element.

In some embodiments, the through port of the last directional coupler in each of the M rows of directional couplers except for the top row of the M rows of directional couplers is coupled to an isolated port of the last directional coupler in the row of the M rows of directional couplers that is below it through a second delay element.

In some embodiments, an isolated port of each directional coupler in the bottom row of the M rows of directional couplers is coupled to electrical ground via a respective matched termination.

In some embodiments, an isolated port of each directional coupler in the bottom row of the M rows of directional couplers is coupled to a combiner, and an output of the combiner is coupled to ground via a matched termination.

In some embodiments, a through port of each directional coupler in each of the M rows of directional couplers except for a last directional coupler in each of the M rows of directional couplers is coupled to the input port of a respective adjacent directional coupler in the row through a respective phase shifter.

In some embodiments, the through port of the last directional coupler in each of the M rows of directional couplers except for a top row of the M rows of directional couplers is coupled to an isolated port of the last directional coupler in the row of the M rows of directional couplers that is below it through a respective phase shifter.

Pursuant to embodiments of the present invention, multibeam antennas are provided that include an antenna array that includes N columns of radiating elements and a first polarization beamforming network having a plurality of rows of directional couplers including a top row and a bottom row, where each row of directional couplers below the top row has one less directional coupler than the row above it. The last directional coupler in the top row has a port that is coupled to ground via a matched termination.

In some embodiments, the top row has N directional couplers, and wherein a coupling port of each directional coupler in the top row is coupled to a respective one of the N columns of radiating elements.

In some embodiments, the multibeam antenna further comprises first through M first polarization RF ports, wherein a first directional coupler in each of the rows of directional couplers is coupled to a respective one of the first polarization RF ports.

In some embodiments, for each of the rows of directional couplers, a through port of each directional coupler in the row except for a last directional coupler in the row is coupled to the input port of an adjacent directional coupler in the row through a respective first delay element.

In some embodiments, for each of the rows of directional couplers except for the top row, the through port of the last directional coupler in the row is coupled to an isolated port of the last directional coupler in the row of directional couplers that is below the row through a second delay element.

In some embodiments, an isolated port of each directional coupler in the bottom row is coupled to electrical ground via a respective matched termination.

In some embodiments, an isolated port of each directional coupler in the bottom row is coupled to a combiner, and an output of the combiner is coupled to ground via a matched termination.

In some embodiments, a through port of each directional coupler except for a last directional coupler in each of the rows is coupled to the input port of an adjacent directional coupler in the row through a respective phase shifter.

In some embodiments, the through port of the last directional coupler in each of the rows of directional couplers except for the top row is coupled to an isolated port of the last directional coupler in the row of directional couplers that is below it through a respective phase shifter.

Pursuant to embodiments of the present invention, multibeam antennas are provided that include an antenna array that includes N columns of radiating elements and a first polarization beamforming network having a plurality of rows of directional couplers including a top row and a bottom row. For each of the rows of directional couplers, a through port of each directional coupler in the row except for a last directional coupler in the row is coupled to the input port of an adjacent directional coupler in the row through a respective first delay element. Additionally, for each of the rows of directional couplers except for the top row, the through port of the last directional coupler in the row is coupled to an isolated port of the last directional coupler in the row of directional couplers that is below the row through a second delay element.

In some embodiments, the top row has N directional couplers, and wherein a coupling port of each directional coupler in the top row is coupled to a respective one of the N columns of radiating elements.

In some embodiments, the multibeam antenna further comprises first through M first polarization radio frequency (“RF”) ports, wherein a first directional coupler in each of the rows of directional couplers is coupled to a respective one of the first polarization RF ports.

In some embodiments, an isolated port of each directional coupler in the bottom row is coupled to electrical ground via a matched termination.

Pursuant to embodiments of the present invention, multibeam antennas are provided that include an antenna array that includes N columns of radiating elements and a first polarization beamforming network having a plurality of rows of directional couplers including a top row and a bottom row and a plurality of additional rows that are between the top row and the bottom row, where the top row and the bottom row each include the same number of directional couplers, and at least one of the additional rows includes less directional couplers than the top row.

In some embodiments, the one of the additional rows that is directly below the top row includes the same number of directional couplers as the one of the additional rows that is directly above the bottom row.

In some embodiments, a through port of the last directional coupler in the top row is coupled to electrical ground via a matched termination.

In some embodiments, a coupling port of each directional coupler in the top row is coupled to a respective one of the N columns of radiating elements.

In some embodiments, a first directional coupler in each of the rows is coupled to a respective one of the first polarization RF ports.

### BRIEF DESCRIPTION OF THE DRAWINGS

FIG. 1A is a schematic block diagram of a conventional Butler Matrix based multibeam sector-splitting base station antenna.

FIG. 1B is a block diagram illustrating how RF signals are distributed to the radiating elements in each column of the multi-column array of FIG. 1A.

FIGS. 2A-2C are azimuth plots of the left three (of six) first polarization antenna beams generated by the conventional base station antenna of FIGS. 1A-1B when excited with RF signals at frequencies of 1.7 GHz, 2.2 GHz and 2.7 GHz that illustrate how the beam peak “walks” in the azimuth plane as a function of frequency.

FIG. 3A is a schematic block diagram of a multibeam sector-splitting antenna that includes an M×N Blass Matrix based beamforming network.

FIG. 3B is a schematic block diagram of a multibeam sector-splitting antenna that includes an M×N Nolen Matrix based beamforming network.

FIG. 4A is a perspective view of a 2T2R multibeam sector-splitting base station antenna according to embodiments of the present invention that includes a modified Nolen Matrix based beamforming network.

FIG. 4B is a schematic front view of the multi-column array included in the base station antenna of FIG. 4A.

FIG. 4C is a schematic block diagram the multibeam sector-splitting base station antenna of FIG. 4A.

FIG. 4D is a greatly enlarged view of the portion of FIG. 4C labelled “4D” that better illustrates the connections between the directional couplers in different rows and columns of the modified Nolen Matrix based beamforming network.

FIG. 5A is a simulated azimuth plot illustrating the main lobes of the six first polarization antenna beams generated by the multibeam antenna of FIG. 4A for RF input signals at five different frequencies.

FIG. 5B is a graph illustrating the simulated beam peak walking performance of the multibeam sector-splitting base station antenna of FIG. 4A.

FIG. 6 is a combination of a side view and several plan views that illustrate a printed circuit board implementation of one of the modified Nolen Matrix beamforming networks included in the multibeam base station antenna of FIG. 4A.

FIG. 7A is a perspective view of a scannable multibeam sector-splitting base station antenna according to still further embodiments of the present invention.

FIG. 7B is a schematic front view of the multi-column antenna array included in the base station antenna of FIG. 7A.

FIG. 7C is a schematic block diagram of the scannable multibeam base station antenna of FIG. 7A

FIG. 7D is a series of graphs illustrating how the pointing direction of the antenna beams generated by a scannable multibeam base station antenna can be scanned in the azimuth plane.

FIG. 8 is a schematic block diagram of a multibeam sector-splitting base station antenna according to still further embodiments of the present invention.

FIG. 9 is a schematic front view of the dual-band base station antenna according to embodiments of the present invention that includes a multi-column array in one of the bands.

FIG. 10 is a schematic block diagram of a multibeam sector-splitting base station antenna according to still further embodiments of the present invention that has a beamforming networks that is a mix of a Blass Matrix and a Nolen Matrix.

### DETAILED DESCRIPTION

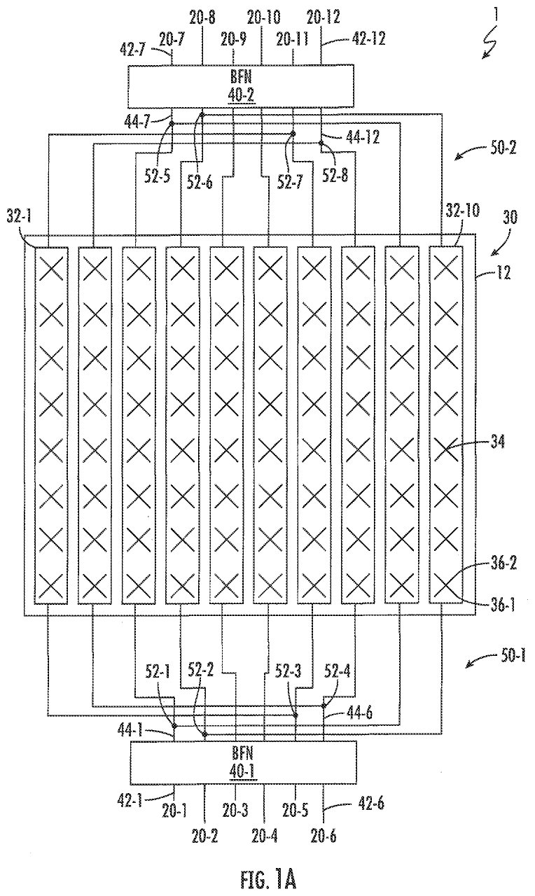

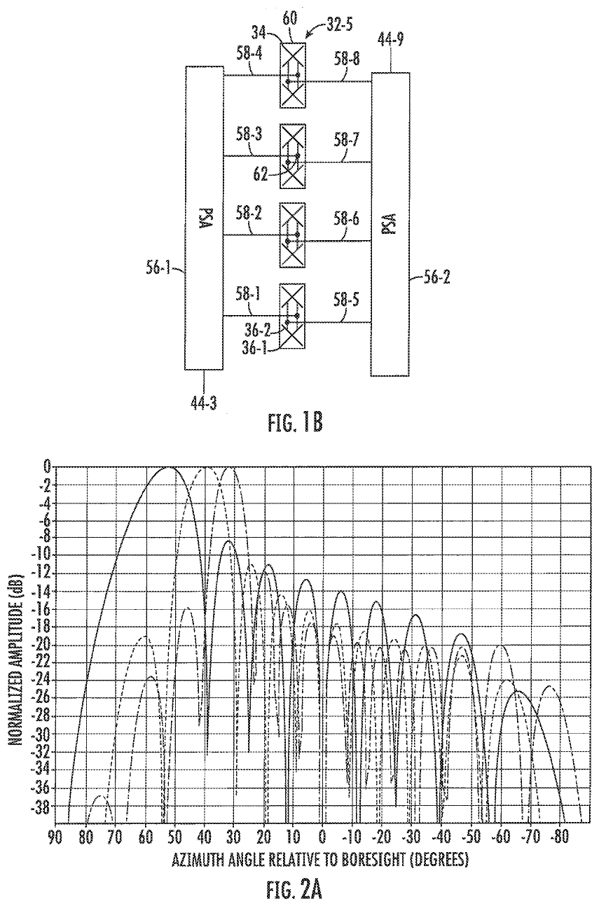

FIGS. 1A and 1B are schematic diagrams that together illustrate the RF signal paths of a conventional Butler Matrix based six-beam (per polarization) sector-splitting antenna 1. In particular, FIG. 1A is a schematic block diagram of base station antenna 1 that illustrates the RF signal paths extending from the RF ports of the antenna to the columns of a multi-column array of radiating elements, and FIG. 1B is a schematic block diagram illustrating how RF signals are distributed to the radiating elements in each column of the multi-column array of radiating elements.

As shown in FIG. 1A, the multibeam sector-splitting base station antenna 1 includes twelve RF connector ports 20-1 through 20-12 (also referred to herein as “RF ports”) that are used to input RF signals to the base station antenna 1 from one or more radios, such as remote radio heads. Herein, when multiple of the same elements are included in an antenna, the elements may be referred to individually by their full reference numeral (e.g., RF connector port 20-2) and collectively by the first part of their reference numerals (e.g., the RF connector ports 20). The antenna 1 further includes an antenna array 30 that has ten columns 32-1 through 32-10 of dual-polarized radiating elements 34 that are mounted to extend forwardly from a reflector 12 (only columns 32-1 and 32-10 are explicitly numbered in FIG. 1A to simplify the drawing; it will be understood that the columns 32 are arranged sequentially in numerical order). Each dual-polarized radiating element 34 includes a first polarization radiator 36-1 and a second polarization radiator 36-2. Base station antenna 1 also includes a pair of beamforming networks (“BFN”) 40-1, 40-2 (one for each polarization) and a pair of feed networks 50-1, 50-2 (again, one for each polarization).

The RF connector ports 20-1 through 20-12 may comprise, for example, RF connectors, and may be connected to RF ports on one or more radios via, for example, coaxial cables. The radios are typically external to the antenna 1 and are not shown in FIG. 1A. Each beamforming network 40 is implemented as a 6×6 Butler Matrix. The six first polarization RF connector ports 20-1 through 20-6 are connected to the six inputs 42-1 through 42-6 of the Butler Matrix 40-1, and the six second polarization RF connector ports 20-7 through 20-12 are connected to the six inputs 42-7 through 42-12 of the Butler Matrix 40-2. The six outputs 44-1 through 44-6 of Butler Matrix 40-1 are connected to the ten-column antenna array 30 by the feed network 50-1, and the six outputs 44-7 through 44-12 of Butler Matrix 40-2 are connected to the ten-column antenna array 30 by the feed network 50-2. Only inputs 42-1, 42-6, 42-7 and 42-12 and only outputs 44-1, 44-6, 44-7 and 44-12 are explicitly numbered in FIG. 1A to simplify the drawing; it will be understood that the inputs and outputs to the beamforming networks 40 are arranged sequentially in numerical order.

As is further shown in FIG. 1A, the feed network 50-1 includes four power dividers 52-1 through 52-4 that are each used to connect selected ones of the outputs 44-1 through 44-6 of Butler Matrix 40-1 to respective pairs of columns 32 of antenna array 30. In particular, power divider 52-1 connects output 44-1 of Butler Matrix 40-1 to the third and ninth columns 32-3 and 32-9, power divider 52-2 connects output 44-2 of Butler Matrix 40-1 to the fourth and tenth columns 32-4 and 32-10, power divider 52-3 connects output 44-5 of Butler Matrix 40-1 to the first and seventh columns 32-1 and 32-7, and power divider 52-4 connects output 44-6 of Butler Matrix 40-1 to the second and eighth columns 32-2 and 32-8. Output 44-3 of Butler Matrix 40-1 is connected to the fifth column 32-5, and output 44-4 of Butler Matrix 40-1 is connected to the sixth column 32-6. Consequently, the six outputs 44-1 through 44-6 of Butler Matrix 40-1 feed all ten columns 32 of antenna array 30. Four additional power dividers 52-5 through 52-8 are provided that connect selected ones of the outputs 44-7 through 44-12 of Butler Matrix 40-2 to respective pairs of columns 32 of antenna array 30 in a similar fashion.

FIG. 1B illustrates the connections between beamforming networks 40-1, 40-2 and the radiating elements 34 of column 32-5 of antenna array 30. As shown in FIG. 1B, output 44-3 of Butler Matrix 40-1 is coupled to a first phase shifter assembly 56-1. The first phase shifter assembly 56-1 includes a 1×4 power divider that divides RF signals input thereto into four sub-components, and also includes an adjustable phase shifter that is configured to impart a phase progression across the four sub-components in order to electronically change the tilt angles of the antenna beams generated by the radiating elements 34 in column 32-5. Each output 58 of the first phase shifter assembly 56-1 is coupled to a respective feed board 60. A pair of radiating elements 34 are mounted on each feed board 60. A power divider 62 is provided on each feed board 60 that sub-divides RF signals input thereto from the respective outputs 58 of the first phase shifter assembly 56-1 into first and second sub-components that are passed to the respective first and second radiating elements 34 mounted on the feed board 60. As can be seen, the portion of feed network 50-1 depicted in FIG. 1B feeds output 44-3 of Butler Matrix 40-1 to the first polarization radiators 36-1 of the radiating elements 34 in column 32-5. A second phase shifter assembly 56-2 and four additional feed board power dividers 62 are provided that are used to similarly feed RF signals that are output from output 44-9 of Butler Matrix 40-2 to the second polarization radiators 36-2 of the radiating elements 34 in column 32-5. It will be appreciated that each of the other nine columns 32 of antenna array 30 are fed in the same manner as shown in FIG. 1B.

The conventional multibeam sector-splitting base station antenna 1 has a number of drawbacks. First, the antenna 1 may be costly to manufacture. In addition, the operating bandwidth may be relatively narrow (e.g., less than 25% of the center frequency of the operating frequency band), and the azimuth HPBW of each of the six antenna beams (at each polarization) may be wider than desired, and may vary significantly with frequency. In addition, the generated antenna beams exhibit significant beam peak walking.

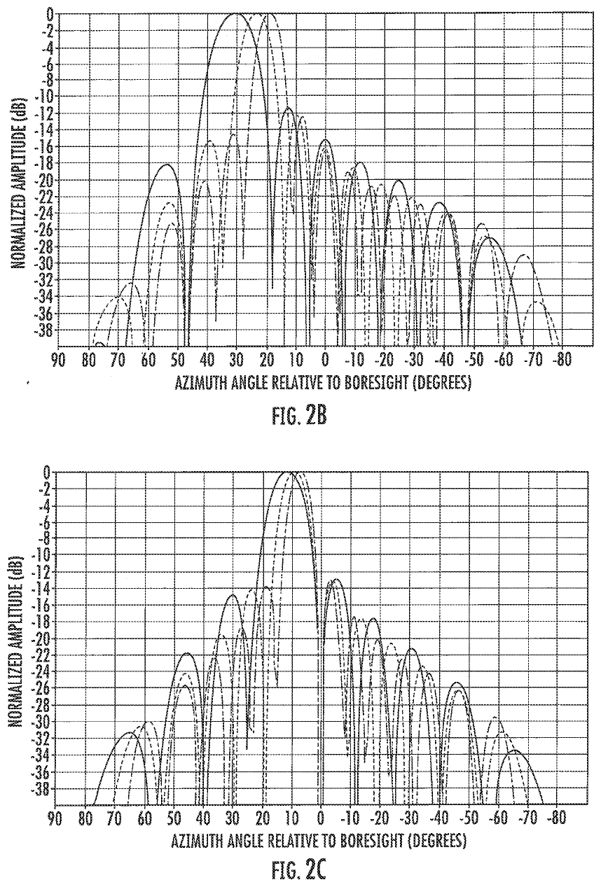

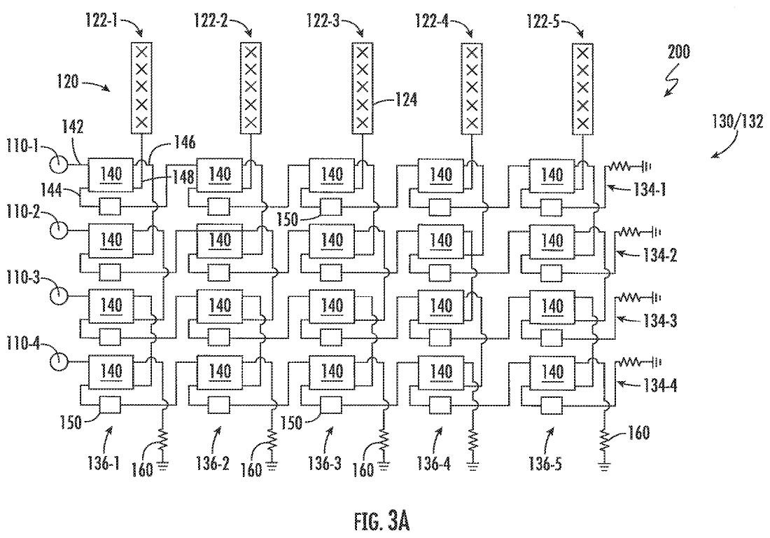

FIGS. 2A-2C are simulated azimuth plots that illustrate three of the six first polarization antenna beams generated by the multibeam sector-splitting base station antenna 1 of FIGS. 1A-1B. Each graph shows the antenna beams that are generated by the antenna 1 when excited with RF signals at frequencies of 1.7 GHz, 2.2 GHz and 2.7 GHz (i.e., at the lowermost frequency, the center frequency and the uppermost frequency of the 1.7-2.7 GHz operating frequency band). FIG. 2A illustrates the leftmost antenna beam for a sector, FIG. 2B illustrates the antenna beam that is adjacent the antenna beam of FIG. 2A, and FIG. 2C illustrates the antenna beam that is adjacent the antenna beam of FIG. 2B. In other words, FIGS. 2A-2C illustrate the three antenna beams that provide coverage to the left half of the 120° sector. The remaining three antenna beams (at each of the three frequencies) that provide coverage to the right half of the 120° sector are mirror images of the antenna beams shown in FIGS. 2A-2C. As shown in FIGS. 2A-2C, the beam peak walking (i.e., the shift in the azimuth angle where peak gain occurs) increases with increasing scan angle, and exceeds 20° with the outermost antenna beams (see FIG. 2A, showing the beam peaks at the two ends of the operating frequency band are at 32° and 53°). This beam peak walking results in a large variation in the power levels of the antenna beams at the outside edges of the sub-sectors as a function of frequency, which is undesirable.

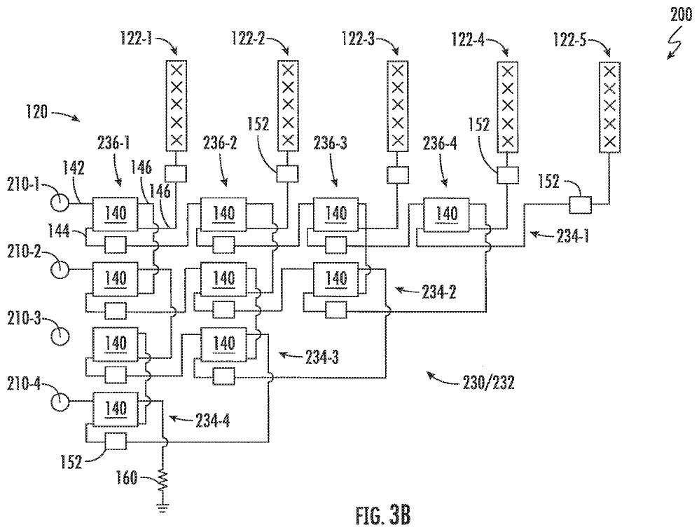

Multibeam antennas have also been proposed that use Blass Matrix or Nolen Matrix based beamforming networks. An M×N Blass Matrix includes M rows and N columns of directional couplers and may be used to feed an antenna array that has N columns of radiating elements. FIG. 3A illustrates a multibeam sector-splitting base station antenna 100 that is implemented using a Blass Matrix based beamforming network. The sector-splitting antenna 100 may split a sector into four sub-sectors, providing a separate antenna beam (per polarization) for each sub-sector.

As shown in FIG. 3A, the multibeam sector-splitting base station antenna 100 includes first through fourth first polarization RF ports 110-1 through 110-4, a multi-column antenna array 120 and a Blass Matrix based beamforming network 130. It will be appreciated that the illustrated beamforming network 130 is for a first polarization, and that if dual-polarized radiating elements are used in the multi-column array 120, a second beamforming network 130 will be provided as will first through fourth second polarization RF ports. The multi-column antenna array 120 includes five columns 122 of radiating elements 124. Each column 122 of radiating elements 124 may extend in a vertical direction, and the columns 122 may be spaced apart from each other in a horizontal direction to form a planar array 120 of radiating elements 124. Each column 122 of radiating elements 124 may further include a power divider network (not shown, but see FIG. 1B for a similar power divider network that also includes a phase shifter) that splits the RF signals fed to the column 122 into a plurality of sub-components that are fed to the respective individual radiating elements 124.

The beamforming network 130 is implemented using a 4×5 Blass Matrix 132. As shown, the Blass Matrix 132 includes twenty directional couplers 140 that are arranged in four rows 134 and five columns 136. “Horizontal” delay lines 150 are provided between adjacent directional couplers 140 in each row 134, such that a total of sixteen horizontal delay lines 150 are provided. The horizontal delay lines 150 may comprise, for example, meandered transmission line segments that add a desired amount of phase delay. Each directional coupler 140 has an input port 142 (the top left port), a through port 144 (the bottom left port), an isolation port 146 (the top right port) and a coupling port 148 (the bottom right port). The four RF ports 110-1 through 110-4, are coupled to the respective input ports 142 of the first (leftmost) directional coupler 140 in each row 134. The coupling port 148 of each directional coupler 140 in the first (topmost) row 134-1 of the Blass Matrix 132 is coupled to a respective one of the columns 122 of radiating elements 124. The isolation port 146 of each directional coupler 140 in the last (bottommost) row 134-4 of the Blass Matrix 132 is coupled to a respective load 160 (e.g., a respective 50 Ohm resistor). The through port 144 of each directional coupler 140 in the last (rightmost) column 136-5 of the Blass Matrix 132 is coupled to a respective load 160 (e.g., a respective 50 Ohm resistor) through a respective one of the horizontal delay lines 150. The remaining ports of the directional couplers 140 are interconnected as shown in FIG. 3A. In particular, the through port 144 of each of the remaining directional couplers 140 is coupled, through a respective one of the horizontal delay lines 150, to the input port 142 of the next directional coupler 140 in the same row 134. Likewise, the isolation port 146 of each directional coupler 140 in a row 134 is coupled to the coupling port 148 of the directional coupler 140 in the row 134 below (except for the isolation ports 146 of the directional couplers 140 in the last row 134, as discussed above).

As noted above, the multibeam sector-splitting base station antenna 100 can generate M (here M equals 4) antenna beams (per polarization) that point in different directions. The Blass Matrix 132, however, is a lossy matrix in both transmitting and receiving, which reduces the gain of antenna 100. In addition, the Blass Matrix 132 requires a large number of directional couplers 140, which may result in a physically large and expensive beamforming network 130.

A Nolen Matrix is another beamforming network implementation for a multibeam sector-splitting antenna base station antenna. An M×N Nolen matrix includes M rows and N columns of directional couplers, where each row has a different number of directional couplers. FIG. 3B illustrates a multibeam sector-splitting base station antenna 200 that is implemented using an M×N Nolen Matrix beamforming network. The multibeam sector-splitting base station antenna 200 may split a sector into four sub-sectors, providing an individual antenna beam (per polarization) for each sub-sector.

As shown in FIG. 3B, the sector-splitting antenna 200 includes first through fourth first polarization RF ports 210-1 through 210-4, a multi-column antenna array 120 and a first polarization beamforming network 230 (additional RF ports 210 and a second beamforming network 230 are provided if the multi-column antenna array 220 includes dual-polarized radiating elements). The multi-column antenna array 220 may be identical to the multi-column array 120 included in sector-splitting antenna 100 of FIG. 3A, so further description thereof will be omitted.

The beamforming network 230 is implemented using a 4×5 Nolen Matrix 232. As shown, the Nolen Matrix 232 includes ten directional couplers 140 that are arranged in four rows 234 and four columns 236. The top row 234-1 includes four directional couplers 140, and each of the remaining rows 234-2 through 234-4 includes one less directional coupler 140 than the row 234 above it. This design halves the number of directional couplers 140 required as compared to a 4×5 Blass Matrix. The directional couplers 140 may be identical to the directional couplers 140 included in sector-splitting antenna 100 of FIG. 3A, so further description thereof will be omitted. “Vertical” delay lines 152 are provided between adjacent directional couplers 140 in each row 234, such that a total of twelve vertical delay lines 152 are provided. Herein, “horizontal” delay lines refer to delay lines that extend between directional couplers that are in the same row, while “vertical” delay lines refer to delay lines that extend between directional couplers in different rows or between directional couplers and the antenna array 120. The vertical delay lines 152 may be implemented in the same fashion as the horizontal delay lines 150 discussed above (e.g., as meandered transmission line segments) with reference to the sector-splitting antenna 100 of FIG. 3A, so further description thereof will also be omitted. The four RF ports 210-1 through 210-4, are coupled to the respective input ports 142 of the first (leftmost) directional coupler 140 in each row 234. The coupling port 148 of each directional coupler 140 in the first (topmost) row 234-1 of the Nolen Matrix 232 is coupled to a respective one of the columns 122 of radiating elements 124. The through port 144 of the last directional coupler 140 in the first (topmost) row 234-1 of the Nolen Matrix 232 is coupled to the final column 122-5 of radiating elements 124 through a vertical delay line 152 The isolation port 146 of the lone directional coupler 140 in the fourth (bottommost) row 234-4 of the Nolen Matrix 232 is coupled to a load 160 (e.g., a 50 Ohm resistor).

The remaining ports of the directional couplers 140 are interconnected as shown in FIG. 3B. In particular, with the exception of the last directional coupler 140 in each row 234, the isolation port 146 of the directional coupler 140 is coupled to the coupling port 148 of the directional coupler 140 in the row 234 below it. With respect to the last (rightmost) directional coupler 140 in each row 234, the isolation port 146 of each directional coupler 140 in all but the bottom row is coupled to the through port 144 of the last directional coupler 140 in the preceding row 234 through a respective vertical delay line 152, and the isolation port 146 of the last (rightmost) directional coupler 140 in the bottom row 234-4 is coupled to a load 160, as discussed above). Likewise, the through port 144 of each directional coupler 140 in each row 234 is coupled to the input port 142 of the next directional coupler 140 in the row (except for the through port 144 of the last directional coupler 140 in each row 234, as discussed above).

The 4×5 Nolen Matrix 232 can be used to generate four antenna beams that point in different directions and which can be electronically scanned over a wide scanning range. Moreover, the Nolen Matrix 232 only includes a single matched loads 160 and hence will exhibit lower losses than the Blass Matrix 132. However, the performance of the Nolen Matrix 232 may not be as good as a corresponding Blass Matrix, because the Nolen Matrix has less parameters which can be adjusted to optimize performance.

Pursuant to embodiments of the present invention, multibeam sector-splitting base station antennas are provided that include beamforming networks that are based on modified versions of the Nolen Matrix. In particular, the multibeam sector-splitting base station antennas according to embodiments of the present invention may each include a modified Nolen Matrix that includes an extra directional coupler in each row of the matrix, which can improve performance. The modified Nolen Matrices disclosed herein may also include “vertical delays” (i.e., delays interposed in between the connections spanning different rows of the modified Nolen Matrix) that may at least partially compensate for the fact that each row has fewer directional couplers than the row above it in the modified Nolen Matrix. The modified Nolen Matrices disclosed herein are not fully lossless when transmitting (as is the case with conventional Nolen Matrices), but the losses during transmission may be very low, and the losses (during transmission and reception) may be considerably lower than a comparable Blass Matrix based multibeam sector-splitting base station antenna.

The modified Nolen Matrix may generate antenna beams having narrower azimuth HPBWs and reduced variation in azimuth HPBW as a function of frequency as compared to conventional multibeam antennas that have Butler Matrix based beamforming networks. The antennas according to embodiments of the present invention may also generate antenna beams having low sidelobe levels and low interference between adjacent antenna beams. In addition, the multibeam antennas according to embodiments of the present invention may exhibit almost no beam peak walking, even over wide frequency ranges, and may be less lossy as compared to conventional multibeam antennas having Blass Matrix beamforming networks. Moreover, the modified Nolen Matrix based beamforming networks included in the multibeam base station antennas according to embodiments of the present invention may include fewer directional couplers than a comparable Blass Matrix-based beamforming network, which reduces both the size and cost of the antenna.

According to some embodiments of the present invention, multibeam base station antennas are provided that include first through M first polarization RF ports, an antenna array that includes N columns of radiating elements, and a first polarization beamforming network having M rows and N columns of directional couplers, where each row has a different number of directional couplers. In these antennas, a top row of the M rows of directional couplers may have the most directional couplers, and each row below the top row may have one less directional coupler than the row above it. A coupling port of each directional coupler in the top row is coupled to a respective one of the columns of radiating elements, and a first directional coupler in each of the rows of directional couplers is coupled to a respective one of the first polarization RF ports.

A through port of the last directional coupler in the top row of directional couplers may be coupled to ground via a matched termination. Moreover, the through port of all but the last directional coupler in each row may be coupled to the input port of the next directional coupler in the row through a respective first delay element.

According to further embodiments of the present invention, multibeam base station antennas are provided that include an antenna array that includes N columns of radiating elements and a first polarization beamforming network having a plurality of rows of directional couplers including a top row and a bottom row, where each row of directional couplers below the top row has one less directional coupler than the row above it. The last directional coupler in the top row has a port that is coupled to ground via a matched termination.

According to additional embodiments of the present invention, multibeam base station antennas are provided that include an antenna array that includes N columns of radiating elements and a first polarization beamforming network having a plurality of rows of directional couplers including a top row and a bottom row. For each of the rows of directional couplers, a through port of each directional coupler in the row except for the last directional coupler is coupled to the input port of an adjacent directional coupler in the row through a respective first delay element. For each of the rows of directional couplers except for the top row, the through port of the last directional coupler in the row is coupled to an isolation port of the last directional coupler in the row of directional couplers that is below the row through a second delay element.

Pursuant to still further embodiments of the present invention, multibeam sector-splitting base station antennas are provided that include first through M first polarization RF ports, an antenna array that includes N columns of radiating elements, a first polarization beamforming network having a plurality of rows of directional couplers including a top row and a bottom row, where each row has a different number of directional couplers, and a first power divider coupled between the first polarization beamforming network and first and second columns of the N columns of radiating elements. The first power divider may be used to couple a column of directional couplers in the first polarization beamforming network to multiple columns of radiating elements, which may allow for the use of smaller beamforming networks.

Pursuant to still further embodiments of the present invention, multibeam antennas are provided that include an antenna array that includes N columns of radiating elements and a first polarization beamforming network having a plurality of rows of directional couplers including a top row and a bottom row and a plurality of additional rows that are between the top row and the bottom row. The top row and the bottom row each include the same number of directional couplers, and at least one of the additional rows includes less directional couplers than the top row.

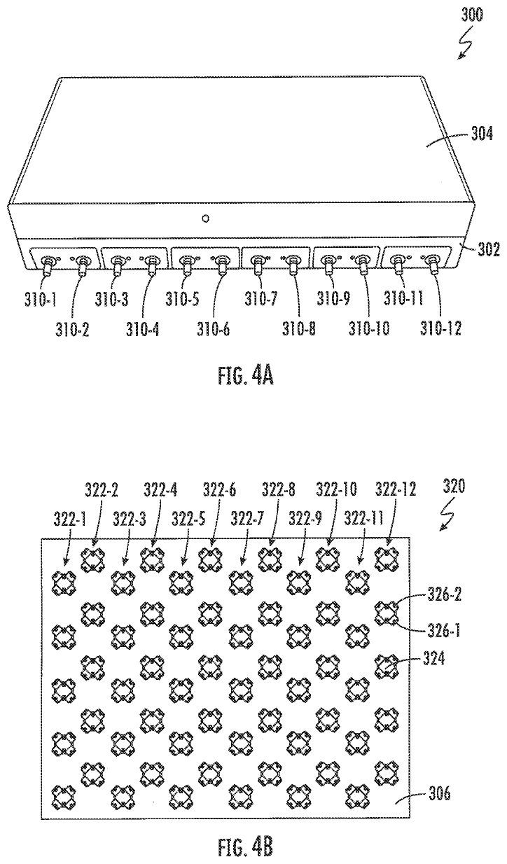

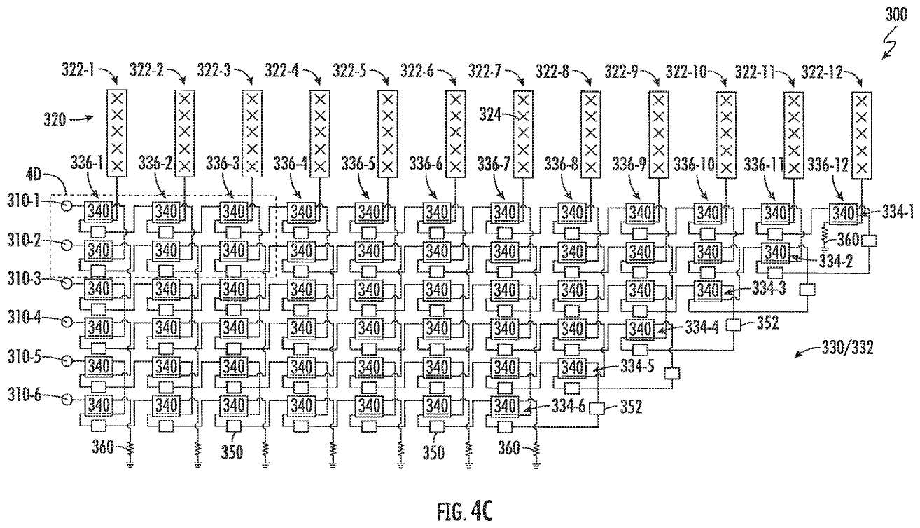

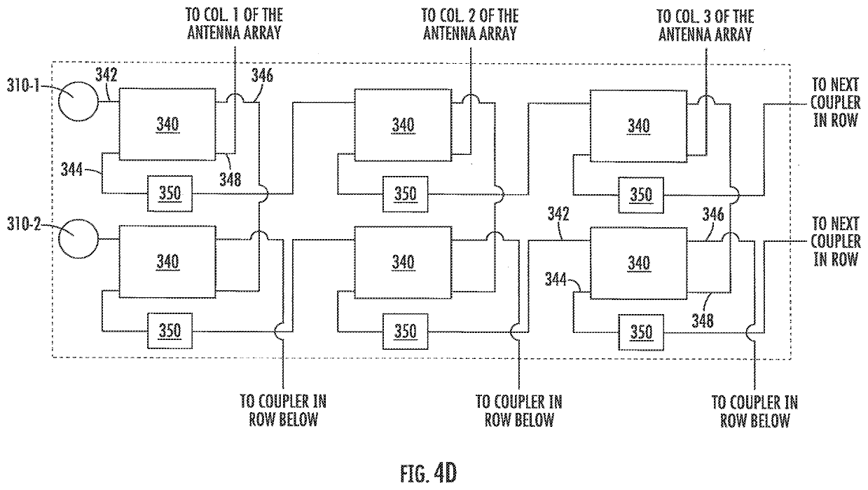

Multibeam sector-splitting base station antennas according to example embodiments of the present invention will now be described in more detail with reference to FIGS. 4A-9.

FIG. 4A is a perspective view of a 2T2R multibeam sector-splitting base station antenna 300 according to embodiments of the present invention. FIG. 4B is a schematic front view of the multi-column antenna array 320 included in the base station antenna 300 of FIG. 4A. FIG. 4C is a schematic block diagram of the multibeam sector-splitting base station antenna 300 of FIG. 4A. FIG. 4D is a greatly enlarged view of the portion of FIG. 4C labelled “4D” that better illustrates the connections between the directional couplers in different rows and columns of the modified Nolen Matrix based beamforming network included in multibeam sector-splitting base station antenna 300.

Referring first to FIG. 4A, the multibeam sector-splitting base station antenna 300 includes a housing 302. At least a front surface of the housing 302 may comprise a radome 304 that is substantially transparent to RF energy in the operating frequency band of base station antenna 300. First through twelfth RF ports 310-1 through 310-12 extend through the housing 302. In the depicted embodiment, each RF port 310 is implemented as an RF connector port. The first through sixth RF ports 310-1 through 310-6 may be first polarization RF ports (meaning that they are connected to first polarization radiators of the radiating elements 324 included in the antenna array 320), and the seventh through twelfth RF ports 310-7 through 310-12 may be second polarization RF ports (meaning that they are connected to second polarization radiators of the radiating elements 324 included in the antenna array 320). Respective radio ports (which may all be on the same radio, or on multiple different radios, not shown) may be connected to the RF ports 310-1 through 310-12 via, for example, respective coaxial cables.

FIG. 4B is a schematic front view of the multi-column antenna array 320, which may be mounted directly behind the radome 304. The multi-column antenna array 320 includes (in this embodiment) twelve columns 322 of dual-polarized radiating elements 324. Each column 322 of radiating elements 324 may extend in a vertical direction, and the columns 322 may be spaced apart from each other in a horizontal direction to form a planar array 320 of radiating elements 324. While not shown in FIG. 4B, each column 322 of radiating elements 324 may further include a power divider network (per polarization) that splits the RF signals fed to the column 322 into a plurality of sub-components that are fed to the respective individual radiating elements 324. The power divider network may optionally include a phase shifter that may be used to apply a phase progression to the sub-components of the RF signal that are fed to the radiating elements in each column 322 of radiating elements 324. The power divider/phase shifter network discussed above with reference to FIG. 1B may be used to implement the power divider/phase shifter network for each column 322, except that each phase shifter assembly shown in FIG. 1B would have five outputs to feed the five radiating elements 324 in the column 322.

Each radiating element 324 may be implemented as a slant −45°/+45° cross-dipole radiating element that includes a first dipole radiator 326-1 that is configured to transmit and receive RF energy having a slant −45° linear polarization and a second dipole radiator 326-2 that is configured to transmit and receive RF energy having a slant +45° linear polarization. It will be appreciated, however, that other types of radiating elements may be used such as dual-polarized patch radiating elements. Each column 322 includes a total of five radiating elements 324, although it will be appreciated that different numbers of radiating elements 324 may be used. The number of radiating elements 324 per column 322 may be selected, for example, based on a desired HPBW in the elevation plane for the antenna beams generated by the multi-column antenna array 320. In the depicted embodiment, adjacent columns 322 are staggered with respect to each other in the elevation (vertical) plane in order to increase the amount of isolation between the radiating elements 324 in adjacent columns 322. The radiating elements 324 may each extend forwardly from a reflector 306 towards the front surface of the radome 304. The reflector 306 may comprise a metallic sheet that serves as a ground plane for the radiating elements 324 and that also redirects forwardly much of the backwardly-directed RF radiation emitted by the radiating elements 324.

FIG. 4C is a schematic block diagram of a beamforming network 330 that is included in the base station antenna 300. FIG. 4D is a greatly enlarged view of the portion of FIG. 4C labelled “4D” that better illustrates the connections between the directional couplers 340 in different rows and columns of the modified Nolen Matrix based beamforming network 330 included in multibeam base station antenna 300 The beamforming network 330 is for a first polarization only, meaning that the beamforming network 330 is coupled between the first polarization RF ports 310-1 through 310-6 and the first polarization radiators 326-1 of the radiating elements 324 in the multi-column antenna array 320. Since the radiating elements 324 are dual-polarized radiating elements, it will be appreciated that the antenna 300 will include a second beamforming network 330 that is coupled between the second polarization RF inputs 310-7 through 310-12 and the second polarization radiators 326-2 of the radiating elements 324 in the multi-column antenna array 320. The second beamforming network may be identical to beamforming network 330, so further description thereof will be omitted.

As shown in FIGS. 4C-4D, the beamforming network 330 is implemented using a modified 6×12 Nolen Matrix 332. As shown, the modified Nolen Matrix 332 includes fifty-seven directional couplers 340 that are arranged in six rows 334 and twelve columns 336. The first (top) row 334-1 includes twelve directional couplers 340, the second row 334-2 includes eleven directional couplers 340, the third row 334-3 includes ten directional couplers 340, the fourth row 334-4 includes nine directional couplers 340, the fifth row 334-5 includes eight directional couplers 340, and the sixth (bottom) row 334-6 includes seven directional couplers 340. Thus, each row 334 has one more directional coupler 340 than the row 334 below it, and one less directional coupler 340 than the row 334 above it.

If each column of the antenna array is to be fed an equal amount of RF power, the first directional coupler 340 in the first row 334-1 may be designed to pass 11/12 of the RF power input at input port 342 to the through port 344, and to pass the remaining 1/12 of the input RF power to the coupled port 348. The second directional coupler 340 in the first row 334-1 may be designed to pass 10/11 of the RF power input at input port 342 thereto to the through port 344 thereof and to pass the remaining 1/11 of the input RF power to the coupled port 348. The third through eleventh directional couplers 340 in the first row 334-1 pass 9/10, 8/9, 7/8, 6/7, 5/6, 4/5, 3/4, 2/3 and 1/2 of the power input at their respective input ports 342 to their respective through ports 344. The last directional coupler 340 in the first row 334-1 may be designed to pass a small portion of the power input thereto to a load 360 (here a 50 ohm resistor), and to couple most of the power to the column 322-12 of radiating elements 324. The directional couplers 340 in the remaining rows 334 may be designed similarly, with the coupling amounts changed to reflect the smaller number of directional couplers 340 in each row 334. It will also be appreciated that in many cases the middle columns of a multi-column array are fed a higher percentage of the RF power than the outer columns, and hence some further adjustment may be made to the coupling ratios for the directional couplers 340 to feed a greater percentage of the power to the middle columns 322 of the array 320.

“Horizontal” delay lines 350 are provided between adjacent directional couplers 340 in each row 334, such that a total of fifty-one horizontal delay lines 350 are provided. In particular, the first (top) row 334-1 includes eleven horizontal delay lines 350, the second row 334-2 includes ten horizontal delay lines 350, the third row 334-3 includes nine horizontal delay lines 350, the fourth row 334-4 includes eight horizontal delay lines 350, the fifth row 334-5 includes seven horizontal delay lines 350, and the sixth (bottom) row 334-6 includes six horizontal delay lines 350. “Vertical” delay lines 352 are also provided that extend between the last (rightmost) directional coupler 340 in each row 334 and the last (rightmost) directional coupler in the row 334 below, such that a total of five vertical delay lines 352 are provided.

As shown in FIG. 4D, each directional coupler 340 has an input port 342 (the top left port), a through port 344 (the bottom left port), an isolation port 346 (the top right port) and a coupling port 348 (the bottom right port). All of the directional couplers 340 in FIGS. 4C-4D are oriented the same way, so that the port labels shown in FIG. 4D for two of the directional couplers 340 apply for all of the directional couplers 340 in FIGS. 4C-4D. Each directional coupler 340 may be designed to couple predetermined amounts of the RF energy that is input at the input port 342 to the through port 344 and to the coupling port 348. Ideally, no RF energy is passed from the input port 342 to the isolation port 346, although in practice a small amount of RF energy will be coupled to the isolation port 346. The directional couplers 340 may also impart a −90° phase shift between the RF energy passed from the input port 342 to the through port 344 as compared to the RF energy passed from the input port 342 to the cross-coupled port 348.

As can be seen in FIG. 4C, the connections between the directional couplers 340 vary based on the locations of the directional couplers 340 within the matrix. In particular, the directional couplers 340 in the center of the modified Nolen Matrix 332 (i.e., not along any outer edge) are interconnected so that the input port 342 is connected, through a respective one of the horizontal delays 350, to the through port 344 of the previous directional coupler 340 in the row 334, the through port 344 is coupled, through a respective one of the horizontal delays 350, to the input port of the next directional coupler 340 in the row 334, the isolation port 346 is connected to the coupling port 348 of the directional coupler 340 in the same column 336 in the next row 334 down, and the coupling port 348 is connected to the isolation port 346 of the directional coupler 340 in the same column 336 in the next row 334 up.

The directional couplers 340 on the outside of the modified Nolen Matrix 332 have slightly different connection schemes. In particular, the input port 342 of the first (leftmost) directional coupler 340 in each row 334 is coupled to a respective one of the first-polarization RF ports 310-1 through 310-6 instead of being coupled to the through port of an adjacent directional coupler 340. The coupling port 348 of each directional coupler 340 in the topmost row 334-1 is coupled to a respective one of the columns 322 of radiating elements 324 instead of being coupled to the isolation port 346 of the directional coupler 340 in a different row 334. The isolation port 346 of each directional coupler 340 in the bottommost row 334-6 is coupled to a respective load 360 (e.g., a respective 50 Ohm resistor) instead of being coupled to the coupling port 348 of a directional coupler 340 in a different row 334. The through port 344 of the last directional coupler 340 in each row 334 is coupled to the isolation port 346 of the last directional coupler 340 in the row 334 above it through a respective one of the vertical delays 352, except for the through port 344 of the last directional coupler 340 in the top row 334-1, which is coupled to a load 360.

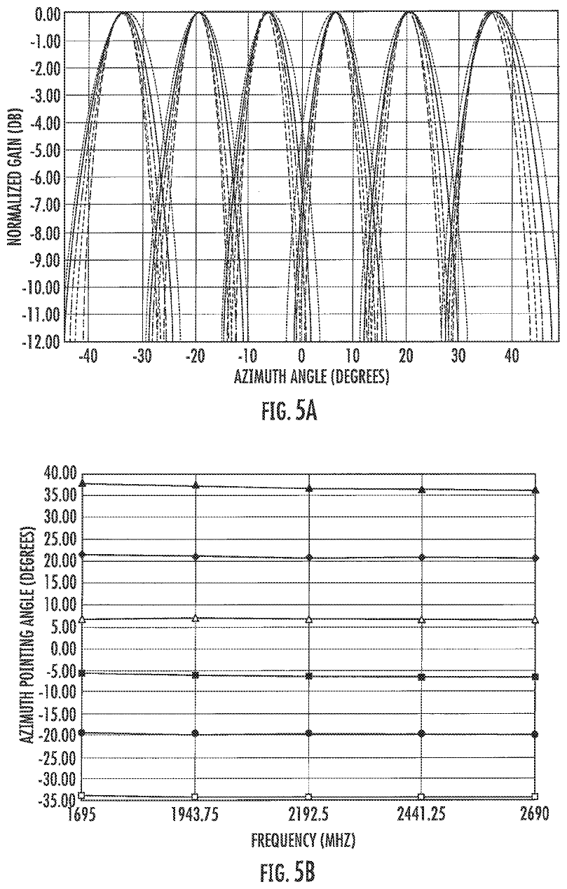

FIG. 5A is a schematic azimuth plot illustrating the six first polarization antenna beams generated by the multibeam antenna of FIG. 4A, where the different curves represent different frequencies spread across the full 1695-2690 MHz frequency band. As shown in FIG. 5A, the six antenna beams provide coverage over a 90° quadrant in the azimuth plane (i.e., the −10 dB point on the left side of the left most antenna beam is separated by about 90° from the −10 dB point on the right side of the right most antenna beam). Thus, the six antenna beams split a 90° sector in the azimuth plane into six 15° sub-sectors. The average crossover for the antenna beams is at −7 dB, which means that each antenna beam provides good coverage within its sub-sector and has relatively low levels of interference with the adjacent sub-sectors. The sidelobe levels are below −12 dB within the coverage area and hence are not visible in FIG. 5A. Moreover, these high levels of performance are maintained over the full 1695-2690 MHz frequency band, showing that the multibeam sector-splitting base station antenna 300 exhibits wideband performance. Thus, FIG. 5A illustrates that the multibeam sector-splitting base station antenna 300 generates antenna beams having good shapes and sizes for dividing a 90° sector in the azimuth plane into six sub-sectors.

FIG. 5B is a graph illustrating the beam peak walking performance of the multibeam sector-splitting base station antenna 300 of FIG. 4A. As discussed above, traditional Butler Matrix based multibeam sector-splitting base station antennas tend to exhibit high levels of beam peak walking, which refers to the phenomena where the pointing direction of the antenna beams (i.e., the angular direction where the antenna beam exhibits peak gain) in the azimuth plane varies as a function of frequency. This phenomena is also referred to as “beam squint.” As described above, beam peak walking can exceed 20° with a conventional six-beam Butler Matrix based base station antenna. As a result, the operating bandwidth of such antennas is often limited to a sub-band (e.g., the 1710-2180 MHz sub-band of the 1695-2690 MHz frequency band when the antenna array includes mid-band radiating elements).

As shown in FIG. 5B, the multibeam antenna 300 exhibits very low levels of beam peak walking over the entire 1695-2690 MHz frequency band. The six curves in the graph of FIG. 5B represent the beam peak walking performance of the six first polarization antenna beams generated by the multibeam antenna 300. While the beam peak walking performance differs slightly between antenna beams, generally speaking the beam peaks only move on average by about 1° in the azimuth plane as a function of frequency across the entire 1695-2690 MHz frequency band. Thus, FIG. 5B shows that the multibeam antenna 300 exhibits excellent beam peak walking performance.

The multibeam sector-splitting base station antenna 300 of FIG. 4A uses a 6×12 modified Nolen Matrix to feed a twelve column antenna array. Pursuant to further embodiments of the present invention, multibeam antennas are provided that include simpler modified Nolen Matrices. The simpler modified Nolen Matrices provide somewhat less control over the shape and size of the antenna beams, but can also reduce the cost of the beamforming networks included in these antennas.

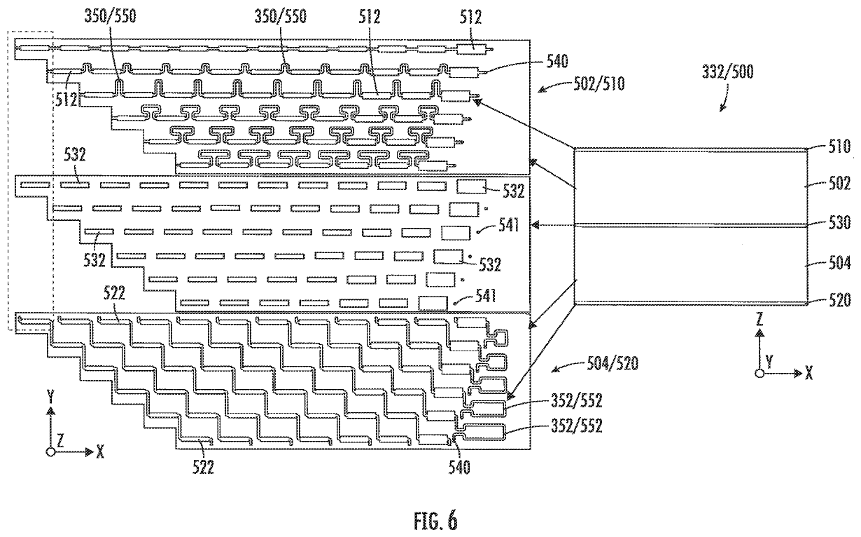

FIG. 6 is a combination of a side view (on the right side of the figure) and several plan views on the left side of the figure) that illustrate a printed circuit board implementation of one of the modified Nolen Matrix beamforming networks 332 included in the multibeam base station antenna 300 of FIG. 4A.

As shown in the side view of FIG. 6, the modified Nolen Matrix 332 may be implemented using a multilayer printed circuit board 500 that includes a first dielectric substrate 502 and a second dielectric substrate 504. A first (top) metallization layer 510 is provided on the top side of the first dielectric substrate 502, a second (bottom) metallization layer 512 is provided on the bottom side of the second dielectric substrate 504, and a third metallization layer is provided in between the two dielectric substrates 502, 504.

The left side of FIG. 6 depicts front views of the first, second and third metallization layers 510, 520, 530. The directional couplers 340 and the delays 350, 352 are formed in these metallization layers 510, 520, 530. The third metallization layer 530 may comprise a substantially solid metal layer that has a plurality of slots 532 formed therein. The dotted box in FIG. 6 encloses the components of one of the directional couplers 340. The directional couplers 340 are formed as slot directional couplers in which a first widened trace 512 is formed in the first metallization layer 510, a second widened trace 522 is formed in the second metallization layer 520, and one of the slots 532 is interposed therebetween. RF energy couples between the first widened trace 512 and the second widened trace 522 through the slot 532. The amount of coupling between the first widened trace 512 and the second widened trace 522 is a function of the length of the slot 532, the width of the slot 532, the thicknesses and dielectric constants of the first and second dielectric substrates 502, 504, and the widths of the first and second widened traces 512, 522. In the depicted embodiment, each slot 532 has the same length (i.e., the same length in the x-direction) and the thicknesses and dielectric constants of the first and second dielectric substrates 502, 504 are constant so the amount of coupling between the first widened trace 512 and the second widened trace 522 may be set by appropriately adjusting the width of the slot 532 and the widths of first and second widened traces 512, 522. In the depicted embodiment the first and second widened traces 512, 522 have the same width for each directional coupler 340, but the widths differ for different directional couplers 340. The widths of the first and second widened traces 512, 522 and the slots 532 may be selected to achieve a desired amount of coupling while also maintaining a desired impedance to minimize return loss.

The input port 342 and the through port 344 of each directional coupler 340 are formed in the first metallization layer 510, and the isolation port 346 and the coupling port 348 of each directional coupler 340 are formed in the second metallization layer 520.

As can further be seen in FIG. 6, the horizontal delays 350 can be implemented as meandered microstrip traces 550 in the first metallization layer 510. As can be seen, the amount of each horizontal delay 350 may be constant within a row of directional couplers 340 and may incrementally increase so that the smallest horizontal delays 350 are in the top row of directional couplers 340 and the largest horizontal delays 350 are in the bottom row of directional couplers 340. Similarly, the vertical delays 352 can be implemented as meandered microstrip traces in the second metallization layer 520. As can be seen, the amount of each vertical delay 352 may incrementally increase so that the smallest vertical delay 352 is in the top row of directional couplers 340 and the largest vertical delay 352 is in the bottom row of directional couplers 340.

As is also shown in FIG. 6, a first plurality of plated through holes 540 are formed through the printed circuit board 500 that electrically connect each vertical delay 352 to the isolation port of a directional coupler 340 in the row above the row that includes the vertical delay 352. Circular regions 541 are provided on the third metallization layer 530 where the metal is omitted so that the plated through holes 540 will not be short-circuited to the metallization of the third metallization layer 530. It should be noted that the matched terminations 360 are not shown in FIG. 6 and may be implemented, for example, as surface mount resistors mounted on the printed circuit board 500.

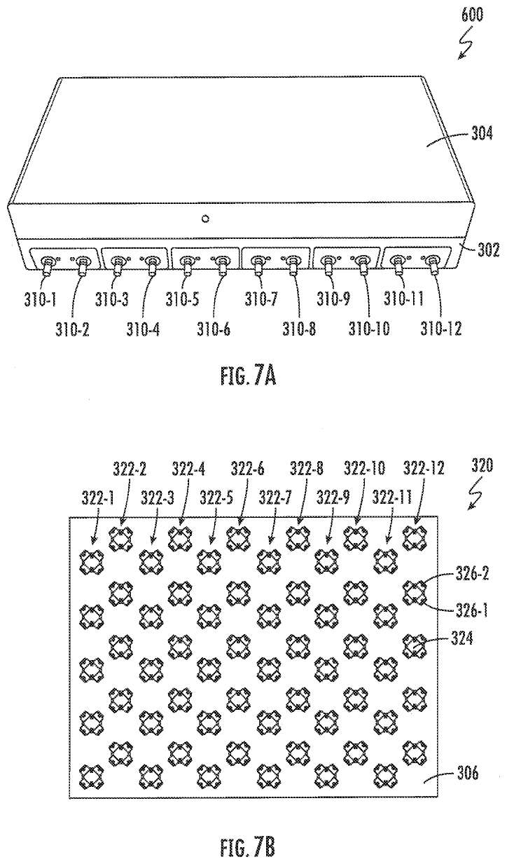

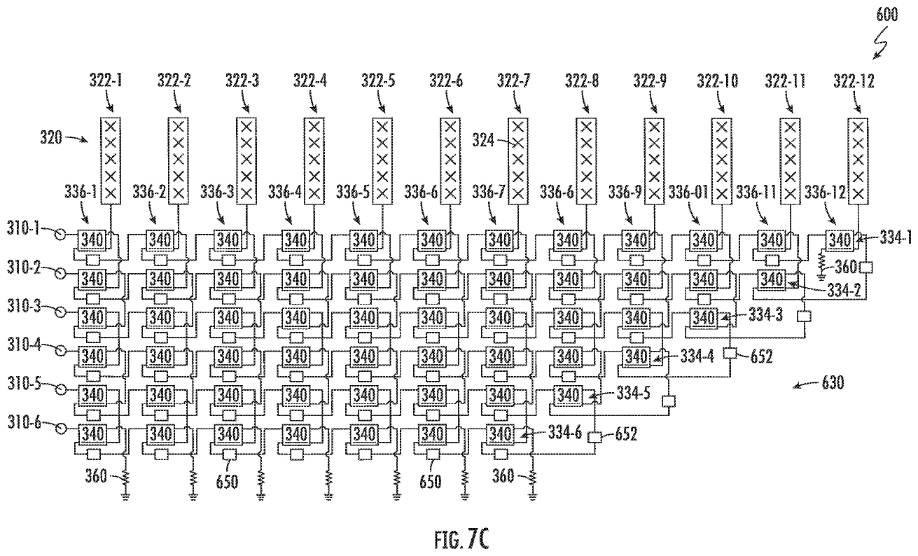

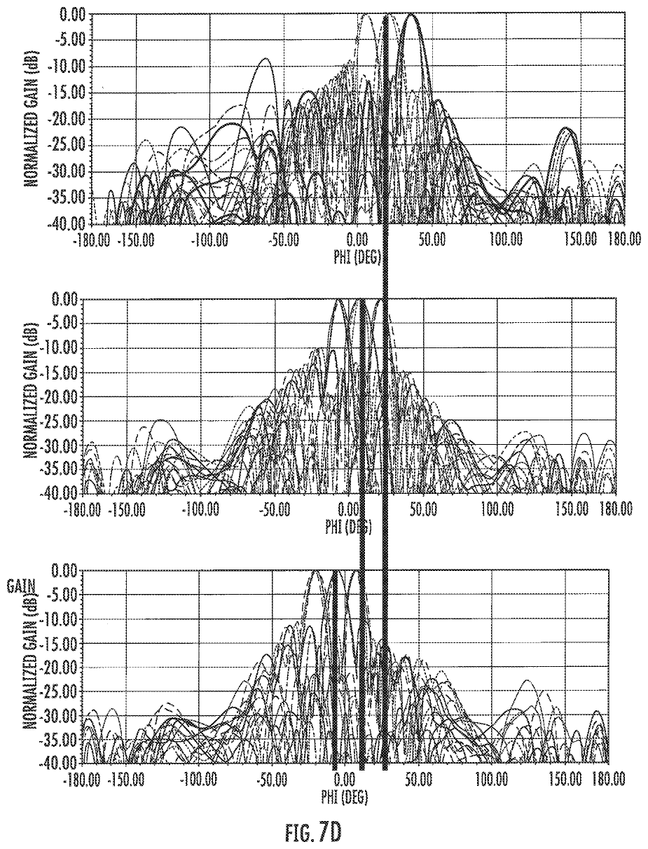

FIG. 7A is a perspective view of a scannable multibeam sector-splitting base station antenna 600 according to still further embodiments of the present invention. FIG. 7B is a schematic front view of the multi-column antenna array included in the base station antenna of FIG. 7A. Referring to FIGS. 7A and 7B, it can be seen that externally the scannable multibeam sector-splitting base station antenna 600 may be identical to multibeam sector-splitting base station antenna 300 discussed above, having a housing 302 that includes a radome 304, a reflector 306, and first through twelfth RF ports 310-1 through 310-12. Multibeam sector-splitting base station antenna 600 may also include a multi-column antenna array 320 that may be identical to antenna array 320 of multibeam sector-splitting base station antenna 300. Thus, further description of these aspects of base station antenna 600 will be omitted.

FIG. 7C is a schematic block diagram of the scannable multibeam base station antenna 600 of FIG. 7A. As can be seen by comparing FIGS. 4C and 7C, the modified Nolen Matrix based beamforming network 630 included in the scannable multibeam base station antenna 600 may be almost identical to the modified Nolen Matrix based beamforming network 330 included in base station antenna 300, with the only difference being that the horizontal and vertical delays 350, 352 included in beamforming network 330 are replaced in beamforming network 630 with adjustable phase shifters 650. The phase shifters 650 may comprise, for example, electromechanical phase shifters such as wiper arc phase shifters or electronic phase shifters.

By replacing the horizontal and vertical delays 350, 352 with phase shifters 650 it is possible to adjust the phase delays between various of the directional couplers 340. This allows a cellular operator to (1) shift the pointing directions of the six antenna beams in the azimuth plane (while keeping the shape and size of the antenna beams substantially the same) and/or (2) to adjust the size of the main lobes of each antenna beam and/or the distance between adjacent main lobes.

FIG. 7D is a series of graphs illustrating how the pointing direction of the antenna beams generated by the scannable multibeam base station antenna can be scanned in the azimuth plane. FIG. 7D shows simulated results for a three beam base station antenna for simplicity. As shown in FIG. 7D, by changing the setting so of the phase shifters, the scannable multibeam base station antenna may scan the pointing direction of the three antenna beams in the azimuth plane. As can be seen, the size and shape of the main lobes of the three antenna beams does not change much as the pointing angles of these antenna beams is scanned, although there are changes in the sidelobes. The ability to shift the pointing direction of the antenna beams may be useful in situations where different coverage areas are desired at different times.

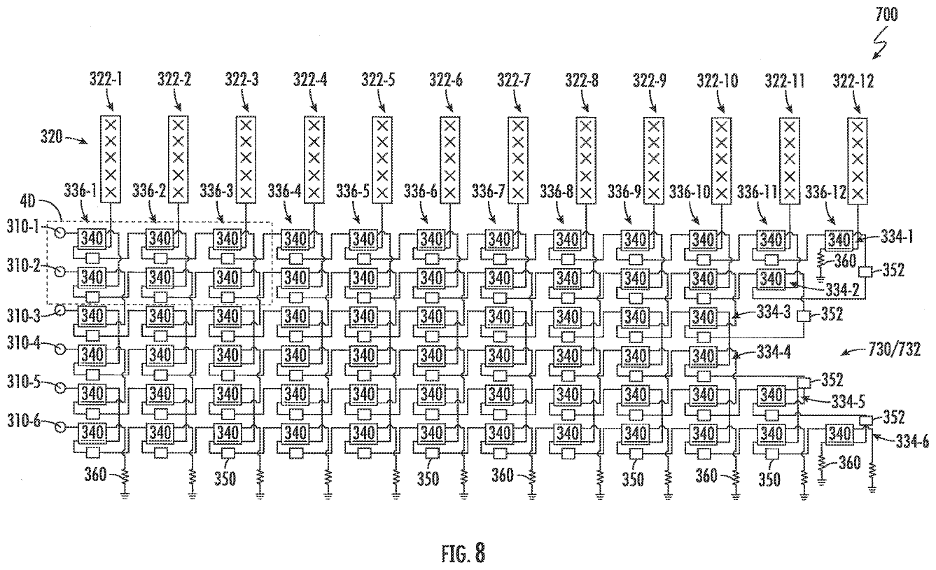

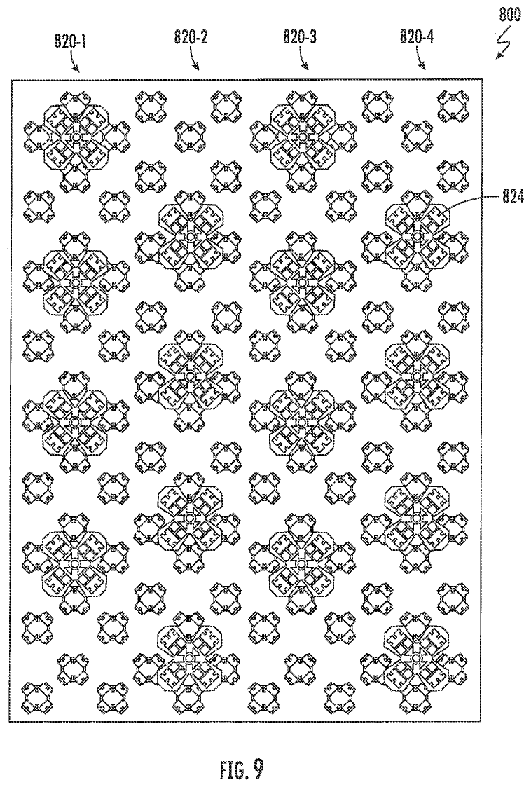

FIG. 8 is a schematic block diagram of a multibeam base station antenna 700 according to still further embodiments of the present invention. The multibeam base station antenna 700 is very similar to multibeam base station antenna of FIGS. 4A-4D so the description below will focus on the differences between these two antennas. As can be seen by comparing FIGS. 4C and 8, the base station antennas 300 and 700 may be identical except for the design of the beamforming networks 330, 730 thereof. Beamforming network 730 differs from beamforming network 330 in that it adds additional directional couplers 340 in rows 734-4 through 734-6 thereof so that a modified Nolen Matrix 732 is provided that is generally symmetrical about a horizontal axis that extends between the third and fourth rows 734-3, 734-4 thereof. Thus, in modified Nolen Matrix 732, the fourth row 734-4 includes ten directional couplers 340, the fifth row 734-5 includes eleven directional couplers 340, and the sixth row 734-6 includes twelve directional couplers 340. The additional directional couplers 340 included in modified Nolen Matrix 732 result in some additional loss as more resistive loads 360 are required, but may result in improved pattern shape (particularly in terms of sidelobe levels in the azimuth plane).

As can be seen in FIG. 8, the multibeam sector-splitting base station antenna 700 includes an antenna array 320 that has N columns 322 of radiating elements 324 and a first polarization beamforming network 730 that has a plurality of rows 334 of directional couplers 340 including a top row 334-1, a bottom row 334-6 and a plurality of additional rows 334-2 through 334-5 that are between the top row 334-1 and the bottom row 334-6. The top row 334-1 and the bottom row 334-6 each include the same number (here 12) of directional couplers 340, and at least one of the additional rows (e.g., row 334-2) includes fewer directional couplers 340 than the top row 334-1. It can also be seen that the second row 334-2 includes the same number of directional couplers 340 as the fifth row 334-5, and that the third row 334-3 includes the same number of directional couplers 340 as the fourth row 334-4.

FIG. 9 is a schematic front view of the dual-band base station antenna 800 according to embodiments of the present invention that includes a multi-column array in one of the bands. Base station antenna 800 may be similar to base station antenna 300 of FIGS. 4A-4D, except that the multi-column antenna array 320 includes more radiating elements 324 per column 322 in base station antenna 800 as compared to base station antenna 300. The radiating elements 324 in multi-column antenna array 320 may be mid-band radiating elements that are configured to operate in the 1427-2690 MHz frequency band or a portion thereof in example embodiments. In addition, base station antenna also includes four linear arrays 820-1 through 820-4 of low-band radiating elements 824 that operate in all or part of the 617-960 MHz frequency band. The low-band radiating elements 824 are positioned in between the mid-band radiating elements 324.

The four linear arrays 820-1 through 820-4 of low-band radiating elements 824 may be operated in any suitable manner. For example, in some embodiments, the four linear arrays 820-1 through 820-4 of low-band radiating elements 824 may be used to implement a sector splitting twin beam (per polarization) antenna in the low-band. In other embodiments, the four linear arrays 820-1 through 820-4 of low-band radiating elements 824 may be used to support 4×MIMO communications in two sub-bands of the low-band operating frequency range, or to support 8×MIMO in one sub-band.

FIG. 9 illustrates one example of a dual-band base station antenna that includes at least a four beam (per polarization) sector splitting capability in a first operating frequency band as well as arrays of radiating elements that operate in a different frequency band. It will be appreciated that linear arrays of low-band radiating elements could be added to any of the base station antennas disclosed herein. For example, two columns of low-band radiating elements could be added to the base station antennas 100 and 200 of FIGS. 3A-3B. The low-band radiating elements could be positioned between the mid-band radiating elements in those antennas in the same fashion as shown in FIG. 9. The base station antennas 600 of FIGS. 7A-7D and/or the base station antenna 700 of FIG. 8 could be modified in the same manner shown in FIG. 9 to include four (or, alternatively, two or three) linear arrays of low-band radiating elements.

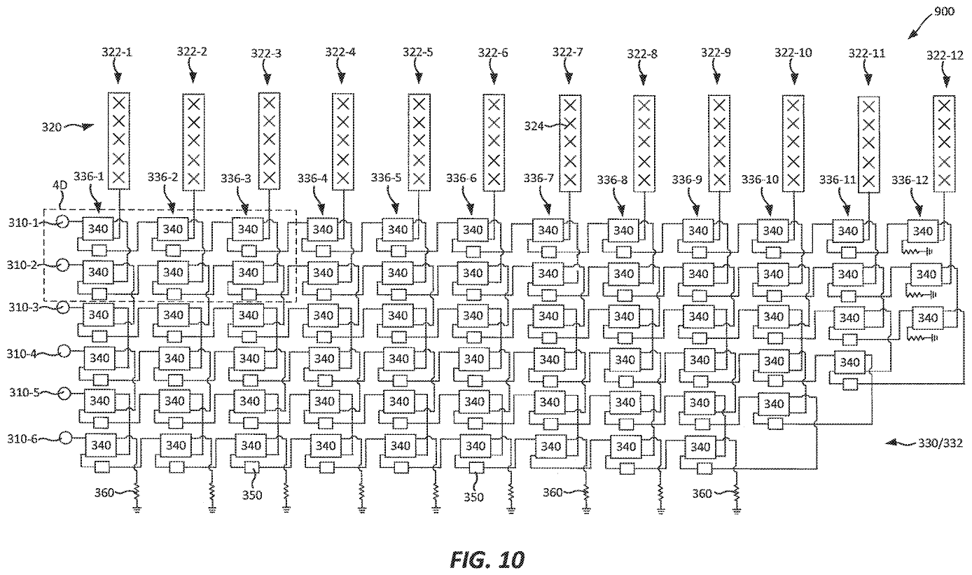

Pursuant to further embodiments of the present invention, multi-beam sector-splitting antennas are provided that include beamforming networks that are a mix of a Blass Matrix and a Nolen Matrix. FIG. 10 is a schematic block diagram of one example of such a “mixed” multibeam sector-splitting base station antenna 900 according to embodiments of the present invention. As shown in FIG. 10, the base station antenna has a beamforming network that is a mix of a Blass Matrix and a Nolen Matrix. In this particular embodiment, the first three beams all have twelve couplers 340 per row, while the remaining three beams have eleven, ten and nine couplers 340 per row. It will be appreciated that the embodiment depicted in FIG. 10 could be changed to have two, three, four or five beams that each have twelve couplers 340 per row in other embodiments of a “mixed” Blass/Nolen Matrix beamforming network.

While the multibeam antennas discussed above are 2T2R antennas (i.e., they support 2×MIMO operation), it will be appreciated that two multibeam antennas according to embodiments of the present invention may be stacked in the same housing to provide multibeam antennas having 4T4R capabilities.

While the above examples of the present invention are primarily of six-beam sector-splitting base station antennas, it will be appreciated that embodiments of the present invention are not limited thereto. In other embodiments the base station antenna may generate fewer than six antenna beams per polarization (e.g., two, three, four or five antenna beams) or may generate more than six antenna beams (e.g., seven, eight, nine or more). Generally speaking, the number of columns of radiating elements tends to increase with an increasing number of antenna beams. For example, a multibeam base station antenna according to embodiments of the present invention that is configured to generate four antenna beams per polarization might have an eight column antenna array. The number of rows in the modified Nolen Matrix-based beamforming networks included in the base station antennas according to embodiments of the present invention may be equal to the number of antenna beams generated by the antenna per polarization. Thus, a four-beam (per polarization) multibeam antenna according to embodiments of the present invention may, for example, include a modified Nolen Matrix-based beamforming network that has four rows and eight columns of directional couplers. The number of antenna columns included in the multibeam base station antennas according to embodiments of the present invention may be set based on desired amounts of sidelobe suppression and interference between adjacent antenna beams. The azimuth beamwidth of each antenna beam may be selected based on the spacing between adjacent columns of radiating elements and the azimuth beamwidth of the individual radiating elements.

In the discussion above, references are made to the “rows” and “columns” of the modified Nolen Matrix beamforming networks according to embodiments of the present invention. It will be appreciated that the “rows” and “columns” are defined functionally and that the directional couplers need not be physically aligned in actual rows and columns when implemented. For example, referring to FIG. 4C, the directional couplers that form row 334-1 are the directional couplers in which the through port 344 of one directional coupler 340 is connected to the input port 342 of the next directional coupler 340 in the row 334-1. Thus, row 334-1 includes a total of twelve directional couplers 340. These directional couplers 340, however, need not be aligned in a horizontal row as shown in FIG. 4C. Instead, some directional couplers 340 in the row 334-1 could be offset in the vertical direction from other of the directional couplers, and may even be aligned in the horizontal direction with the directional couplers 340 of other rows 334. Similarly, the directional couplers 340 that form column 336-1 are the directional couplers 340 in which the coupling port 348 of one directional coupler 340 is connected to the isolation port 346 of the next directional coupler 340 in the column 336-1. Thus, column 336-1 includes a total of six directional couplers 340. These directional couplers 340, however, need not be aligned in a vertical column as shown in FIG. 4C. Instead, some directional couplers 340 in the column 336-1 could be offset in the horizontal direction from other of the directional couplers 340, and may even be aligned in the vertical direction with the directional couplers 340 of other columns 336.

It will be appreciated that the present specification only describes a few example embodiments of the present invention and that the techniques described herein have applicability beyond the example embodiments described above.

The description above primarily describes the transmit paths through the base station antennas described herein. It will be appreciated that base station antennas include bi-directional RF signal paths, and that the base station antennas will also be used to receive RF signals. In the receive path, RF signals will typically be combined whereas the RF signals are split in the transmit path. Thus, it will be apparent to the skilled artisan that the base station antennas described herein may be used to receive RF signals.

Embodiments of the present invention have been described above with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “on” another element, it can be directly on the other element or intervening elements may also be present. In contrast, when an element is referred to as being “directly on” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, operations, elements, and/or components, but do not preclude the presence or addition of one or more other features, operations, elements, components, and/or groups thereof.

Aspects and elements of all of the embodiments disclosed above can be combined in any way and/or combination with aspects or elements of other embodiments to provide a plurality of additional embodiments.

1. A multibeam antenna, comprising:
first through M first polarization radio frequency (“RF”) ports;
an antenna array that includes N columns of radiating elements;
a first polarization beamforming network having M rows and N columns of directional couplers, where each row has a different number of directional couplers, where M and N are natural numbers.

2. The multibeam antenna of claim 1, wherein a top row of the M rows of directional couplers has the most directional couplers and each row below the top row has one less directional coupler than the row above it.

3. The multibeam antenna of claim 2, wherein a coupling port of each directional coupler in the top row of the M rows of directional couplers is coupled to a respective one of the N columns of radiating elements.

4. The multibeam antenna of claim 2, wherein a first directional coupler in each of the rows of directional couplers is coupled to a respective one of the first polarization RF ports.

5. The multibeam antenna of claim 4, wherein a through port of the last directional coupler in the top row of the M rows of directional couplers is coupled to electrical ground via a matched termination.

6. The multibeam antenna of claim 2, wherein a through port of each directional coupler in each of the M rows of directional couplers except for a last directional coupler in each of the M rows of directional couplers is coupled to the input port of a respective adjacent directional coupler in the row through a respective first delay element.

7. The multibeam antenna of claim 6, wherein the through port of the last directional coupler in each of the M rows of directional couplers except for the top row of the M rows of directional couplers is coupled to an isolated port of the last directional coupler in the row of the M rows of directional couplers that is below it through a second delay element.

8. (canceled)

9. The multibeam antenna of claim 2, wherein an isolated port of each directional coupler in the bottom row of the M rows of directional couplers is coupled to a combiner, and an output of the combiner is coupled to ground via a matched termination.

10-11. (canceled)

12. A multibeam antenna, comprising:
an antenna array that includes N columns of radiating elements; and
a first polarization beamforming network having a plurality of rows of directional couplers including a top row and a bottom row, where each row of directional couplers below the top row has one less directional coupler than the row above it,
wherein the last directional coupler in the top row has a port that is coupled to ground via a matched termination.

13. The multibeam antenna of claim 12, wherein the top row has N directional couplers, and wherein a coupling port of each directional coupler in the top row is coupled to a respective one of the N columns of radiating elements.

14. The multibeam antenna of claim 13, further comprising first through M first polarization radio frequency (“RF”) ports, wherein a first directional coupler in each of the rows of directional couplers is coupled to a respective one of the first polarization RF ports.

15. The multibeam antenna of claim 14, wherein for each of the rows of directional couplers, a through port of each directional coupler in the row except for a last directional coupler in the row is coupled to the input port of an adjacent directional coupler in the row through a respective first delay element.

16. The multibeam antenna of claim 15, wherein for each of the rows of directional couplers except for the top row, the through port of the last directional coupler in the row is coupled to an isolated port of the last directional coupler in the row of directional couplers that is below the row through a second delay element.

17. (canceled)

18. The multibeam antenna of claim 16, wherein an isolated port of each directional coupler in the bottom row is coupled to a combiner, and an output of the combiner is coupled to ground via a matched termination.

19. The multibeam antenna of claim 12, wherein a through port of each directional coupler except for a last directional coupler in each of the rows is coupled to the input port of an adjacent directional coupler in the row through a respective phase shifter.

20. The multibeam antenna of claim 12, wherein the through port of the last directional coupler in each of the rows of directional couplers except for the top row is coupled to an isolated port of the last directional coupler in the row of directional couplers that is below it through a respective phase shifter.

21. A multibeam antenna, comprising:
an antenna array that includes N columns of radiating elements; and
a first polarization beamforming network having a plurality of rows of directional couplers including a top row and a bottom row,
wherein for each of the rows of directional couplers, a through port of each directional coupler in the row except for a last directional coupler in the row is coupled to the input port of an adjacent directional coupler in the row through a respective first delay element, and
wherein for each of the rows of directional couplers except for the top row, the through port of the last directional coupler in the row is coupled to an isolated port of the last directional coupler in the row of directional couplers that is below the row through a second delay element.

22. The multibeam antenna of claim 21, wherein the top row has N directional couplers, and wherein a coupling port of each directional coupler in the top row is coupled to a respective one of the N columns of radiating elements.

23. The multibeam antenna of claim 22, further comprising first through M first polarization radio frequency (“RF”) ports, wherein a first directional coupler in each of the rows of directional couplers is coupled to a respective one of the first polarization RF ports.

24. The multibeam antenna of claim 23, wherein an isolated port of each directional coupler in the bottom row is coupled to electrical ground via a matched termination.

25-29. (canceled)
